(19) United States
(12) Patent Application Publication
(10) Pub. No.: US 2003/0044152 A1
(43) Pub. Date: Mar. 6, 2003

(54) Waveguide formation

(75) Inventor: Michael Bazylenko, Eveleigh (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Redfern Integrated Optics Pty Ltd, Eveleigh (AU)

(21) Appl. No.: 09/946,394

(22) Filed: Sep. 4, 2001

(51) Int. Cl. G02B 6/10; C03B 37/022

(52) U.S. Cl. 385/129; 65/386

(57) ABSTRACT

The invention resides in a method of forming a waveguide structure comprising the steps of forming a silica based waveguide on a substrate; annealing one or more localised regions of said waveguide to permanently set the refractive index profile of said localised regions relative to other regions of said waveguide. In a particular form of the invention a core-forming layer is formed and selected regions of the core-forming layer are annealed to reduce their refractive, index thereby defining a core region therebetween. Other applications of the invention reside in reducing bend losses in bent waveguides, and forming long-period gratings in planar waveguides.

### FIELD OF THE INVENTION

This invention relates to methods of forming photonic waveguides and waveguide structures using localised heating to set a desired refractive index profile. The invention further relates to waveguides and structures written by such a method.

### BACKGROUND OF THE INVENTION

In the formation of planar waveguides, it is typical to create a waveguide core by forming a layer of core-forming material and then etching the unwanted regions of the core layer using masks to leave a core of the desired structure. The core is then encapsulated in a layer of cladding material.

One problem with this method is that of sidewall roughness. This is a problem that occurs when using masks to form the shape of sections of the waveguide, in particular the core. The edge of a mask will typically not be perfectly smooth but will have many small irregularities which get translated into the boundary between the core and the adjacent cladding during subsequent etching and deposition steps. These irregularities tend to cause scattering losses.

A further problem is that complex structures such as gratings can require many masking and etching steps.

Photonic waveguides can be formed by many processes eg flame hydrolysis of a suitable precursor powder or by a Plasma-Enhanced Chemical Vapour Deposition (PECVD) process. With many waveguides, dopants need to be added to either the core or the cladding in order to produce a waveguide or optical structure having the desired optical characteristics.

An example of a method of modifying a planar waveguide is U.S. Pat. No. 5,117,470 to Inoue et al., in which it has been proposed to thermally process a waveguide which is initially formed at a high temperature (about 1200° C.), so as to adjust the effective refractive index. The thermal processing involves heating the waveguide to a temperature which is below its formation temperature and melting point, followed by rapidly cooling the waveguide to room temperature. The process of post-deposition adjustment of the effective refractive index of a waveguide is sometimes referred to as “trimming”. One disadvantage of this prior art trimming process is that the initial formation temperature is quite high. Where the waveguide is integrated with other components such as active optical device structures or electronic elements, those structures typically cannot withstand temperatures in excess of 1000° C. A further disadvantage is that the process described in U.S. Pat. No. 5,117,470, which is dependent on a rapid cooling after the heating step, is only effective in regions of the waveguide which contain particular dopants, such as in the cladding layers of the waveguide.

It is an object of the present invention to provide an alternative method for producing photonic waveguides and optical structures incorporating such waveguides.

### SUMMARY OF THE INVENTION

In a first aspect, the invention provides a method of forming a photonic waveguide structure comprising the steps of forming a silica-based waveguide on a substrate, said formed waveguide having a first refractive index profile; and annealing one or more localised regions of said waveguide to permanently set a new refractive index profile in said localised regions.

In a second aspect, the invention provides a method of forming a photonic waveguide comprising the steps of: forming a buffer layer on a planar substrate; forming a silica-based core-forming layer on said buffer layer; heating one or more selected regions of said core-forming layer to a temperature sufficient to permanently reduce the refractive index of said selected regions; and forming a cladding layer over said core-forming layer; wherein said selected regions define the boundaries of a light guiding core within said core-forming layer having a higher refractive index relative to said selected regions.

A particular advantage of the present invention is its ability to combat the problem of sidewall roughness, The use of localised heating, such as with one or more thin film heating structures, to define the core/cladding interface as in the present invention can produce a smoother interface than is possible using typical etching techniques.

Preferably the heating step includes the step of forming at least one heater element over said selected regions of said core-forming layer and operating the or each heater element to heat said selected regions. The steps of forming and operating the or each heater element may occur prior to or post formation of the cladding layer.

Preferably said core-forming layer is deposited with a higher material density than said cladding layer and/or said buffer layer.

In a preferred embodiment, the or each heater element is shaped, e.g. curved, such that a core is produced with a predetermined planar layout.

In a further aspect, the invention provides method of modifying a planar silica-based waveguide comprising a light-guiding core at least partially encapsulated in a cladding region, the method comprising: heating a selected portion of the cladding region adjacent said core so as to permanently reduce a refractive index of the selected portion and to increase a contrast in refractive index between said selected portion and said core.

In one preferred embodiment, the selected portion of said cladding is a portion adjacent said core and on an outside curvature of a bend in said core.

Preferably the step of heating includes the step of forming one or more heating elements over said selected portion of said cladding and operating said one or more heating elements to heat said selected portion.

In a further aspect, the invention provides a method of producing a planar waveguide comprising the steps of: forming a planar silica-based waveguide including a core; non-uniformly annealing at least a portion of said waveguide core so as to produce a non-uniform refractive index profile in said annealed portion of said waveguide core.

In one embodiment, said portion is annealed by applying a heat density gradient that varies along an optical propagation axis of said waveguide so as to produce a permanent refractive index profile in said portion which varies along said propagation axis.

Alternatively, the step of annealing may comprise applying a heat density gradient which varies transverse to the propagation axis.

Preferably the step of applying a heat density gradient includes the steps of forming one or more heater elements over said portion of said waveguide and operating the or each heater to apply said heat density gradient. In one embodiment, the one or more heater elements include a single tapered heating element. In a separate embodiment, the heater elements comprises an array of separately-powered heating elements formed over sections of said waveguide, wherein each heating element provides a separate heat density to the respective section of the waveguide.

In a further aspect, the present invention provides a method of writing a grating in a photonic waveguide including the steps of forming a silica-based waveguide including a core, heating a plurality of selected regions of said core to a temperature sufficient to permanently alter the refractive index of said selected regions, wherein said selected regions have a predetermined spaced relationship relative to each other.

Preferably said step of heating includes forming at least one heater over said selected regions and operating the or each heater so as to alter the effective refractive index of said selected regions.

Preferably the step of forming said at least one heater comprises depositing at least one thin film heating structure.

For each of the above aspects of the invention, the method preferably includes the step of analysing the waveguide to determine the refractive index profile and thus the amount of annealing required. The step of analysing may occur prior to annealing or during the annealing process.

Preferably, the waveguide is formed at a temperature lower than the melting temperature of the material of the waveguide. More preferably, the step of heating or annealing comprises heating the selected regions to a temperature above the formation temperature of the waveguide and below the melting temperature of the waveguide.

For each of the above-described methods, it is preferred that the step of heating heats the relevant region of the waveguide above approximately 700° C.

In a further aspect the invention resides in an optical waveguide structure comprising a silica-based planar optical waveguide, at least one heater formed to heat a plurality of selected regions of said waveguide, said regions having a predetermined spaced relationship relative to each other, wherein the or each heater is operable to heat at least a core of said waveguide to an annealing temperature which alters the effective refractive index of said selected regions.

In a further aspect, the invention resides in an optical waveguide grating comprising a silica-based planar optical waveguide and at least one heater operable to heat a plurality of selected regions of said waveguide, said regions having a predetermined spaced relationship relative to each ocher, wherein said selected regions have been heated by the or each heater to alter the refractive index of said selected regions to produce said grating.

In one embodiment, the spacing between successive ones of said selected regions is constant.

In a further embodiment, the regions are in the form of a Bragg grating.

In a further embodiment, the grating is in the form of a chirped grating wherein the spacing between successive ones of said selected regions alters by a constant amount along the length of the grating.

In a yet further embodiment, the grating is an apodized grating wherein the refractive index at the ends of said plurality of regions is altered to a lesser extent than the selected regions between the end regions.

Preferably each heater is a thin film heater capable of raising the temperature of at least a core of the waveguide in the selected regions to an annealing temperature.

### BRIEF DESCRIPTION OF THE DRAWINGS

The invention will now be described by way of example with reference to preferred though non-limiting embodiments and to the accompanying drawings in which:

FIG. 1 is a schematic cross section of a waveguide during a formation process;

FIG. 2 is a cross section of the waveguide of FIG. 1 after an annealing step;

FIG. 3 is a cross section of the waveguide of FIG. 2 after a final deposition process;

FIG. 4 is a schematic plan view of heater elements used in forming a waveguide with a bend;

FIG. 5 is a cross section of a partially-completed waveguide during an alternative formation process;

FIG. 6 is a plan of the waveguide of FIG. 5;

FIG. 7 is a cross section of the waveguide of FIG. 5 after further etching and deposition;

FIG. 8 is a plan view of a waveguide having a longitudinal array of heating elements formed thereon;

FIG. 9 is a plan of a waveguide with a bend in the core;

FIG. 10 is a schematic plan view of a waveguide having a series of heaters formed thereon (contact pads not shown);

FIG. 11 is a cross section taken along the line 11-11 in FIG. 10; and

FIG. 12 is a graph of a grating profile qualitatively showing the effective refractive index along the length of the waveguide.

### DETAILED DESCRIPTION OF PREFERRED EMBODIMENTS

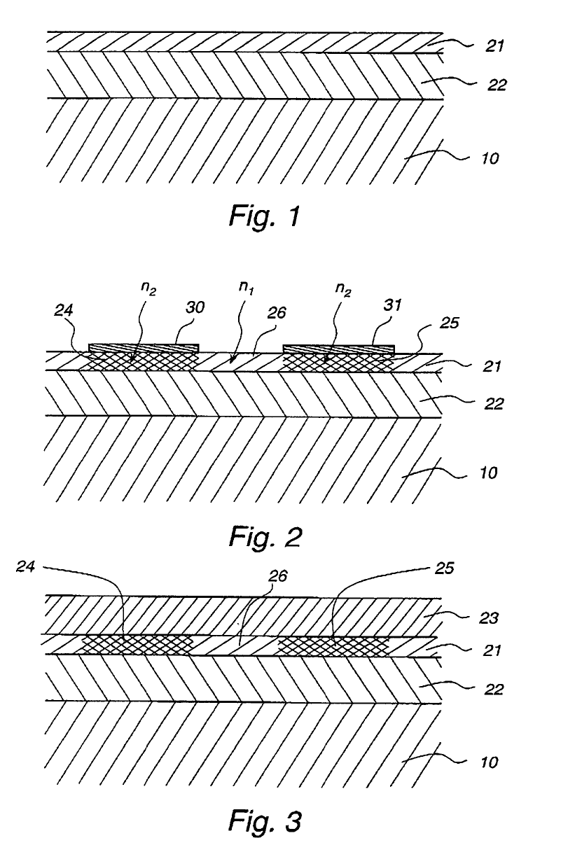

A method of forming a waveguide will now be described with reference to FIGS. 1 to 3. In FIG. 1 there is shown a substrate 10 on which has been deposited a buffer layer 22 and a core-forming layer 21 using a known Plasma-Enhanced Chemical Vapour Deposition (PECVD) process. The buffer layer 22 and core-forming layer 21 are substantially homogenous layers with the core-forming layer in particular having a substantially uniform refractive index nᵢ. It is preferred that the PBCVD process, in particular the deposition of the core-forming layer, is carried out using a liquid silicon-containing source material such as tetraethoxysilane (TEOS) for the precursor vapour. and is conducted in the absence of nitrogen or nitrogen-containing source materials. During the PECVD process, the substrate 10 is maintained at a formation temperature T₁ which is below the melting temperature of the waveguide material. The temperature at which the layers are deposited will vary depending on the requirements of the waveguide but for a generic waveguide, the deposition temperature is chosen to be as low as possible, for example approximately 350° C. A low deposition temperature allows the resultant waveguide to be annealed with broad parameters to suit later requirements, as discussed in the co-pending U.S. patent application Ser. No. ______ titled “Planar Waveguide and Method of Formation” lodged on the same day as the present application, and assigned to Redfern Integrated Optics Pty. Ltd., the contents of which are incorporated herein by reference.

In prior art methods of PECVD deposition of waveguides, the core would be formed by etching the core-forming layer 21 to achieve the desired shape of the core, after which a cladding layer would be deposited over the core structure. In the present method, the core-forming layer is left substantially in tact, Instead, as shown in FIG. 2, the boundaries of the core within the core-forming layer are defined by first depositing a plurality of thin film heater elements 30, 31 on the core-forming layer using known deposition techniques. The heater elements are then operated by being provided with a current through contact pads (not shown). Heat from the elements 30, 31 is transferred to the localised regions 24,25 beneath the elements 30, 31 respectively to heat the regions 24,25 to a temperature above the formation temperature T₁ of the core-forming layer 21. This heating produces a localised change in the refractive index from the formation index n₁ to a lower value n₂ as indicated in FIG. 2. The resultant structure of the core-forming layer has a core region 26 of relatively high refractive index n₁ bounded on each side by a region 24, 25 of reduced refractive index n₂ that is thus capable of confining a light ray to the core region 26.

After annealing, the heater elements 30, 31 are removed, for example by etching and a cladding layer 23 is deposited over the core-forming layer 21 (FIG. 3).

In order to guide an optical signal within the core region 26, the buffer layer 22 and cladding layer 23 should have a lower refractive index than the core region. Where the layers 21, 22, 23 all have substantially the same silica composition, this can be achieved by depositing the separate layers 21, 22, 23 at different material densities. As is known, a low density results in a low refractive index. In one embodiment, the buffer layer 22 and cladding layer 23 are deposited at a density only just great enough to avoid the production of voids in the layer whilst the core-forming layer is deposited at a higher density. The density of a deposited layer can be controlled by controlling ion bombardment during the PECVD, as disclosed in U.S. Ser. No. 60/290,374 entitled “Silica-based optical device fabrication”, the contents of which are hereby incorporated by cross-reference.

An alternative approach to raising the refractive index of the core-forming layer 21 relative to the buffer and cladding layers 22, 23 is to either dope the buffer and cladding layers with a refractive-index-decreasing dopant, such as fluorine or boron, or to dope the core-forming layer 21 with a refractive-index-increasing dopant such as germanium. In both cases, the annealing step has the effect of depressing the refractive indices of regions 24, 25 either side of the core region 26.

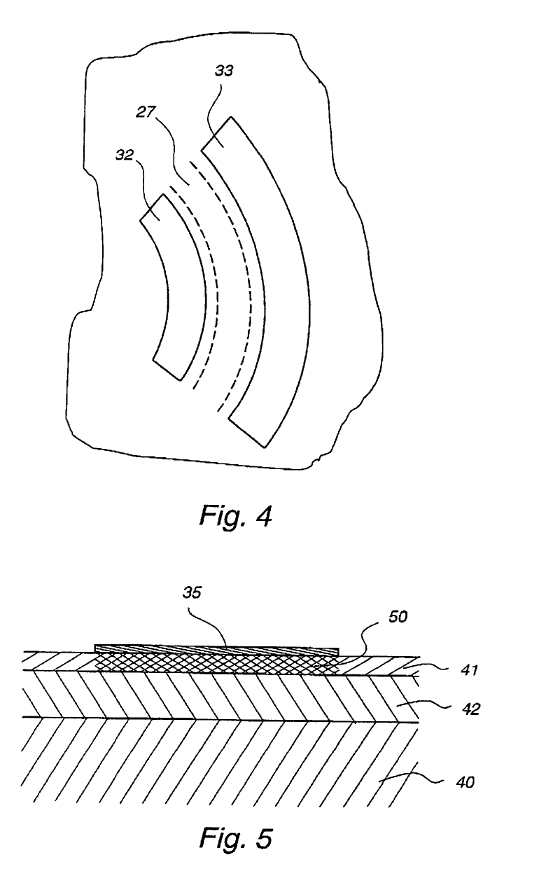

As will be appreciated by the skilled reader, the shape of the core (as seen in a plan view) defined using the above described method will be determined by the layout of the heater elements employed. For example, a waveguide core 27 can be formed with a bend by using a pattern spaced-apart curved heater elements 32, 33 as illustrated in FIG. 4. Alternatively, or additionally, the spacing between the heaters may be varied to produce a variation in core width (as measured in the direction parallel to the substrate) such as a tapered region.

Whilst the embodiment of FIGS. 1 to 3 illustrates forming the thin film heater elements directly on the core-forming layer 21, it may be equally appropriate to first form the cladding layer and then deposit the thin film heater elements on the cladding layer. The core will thus be defined by annealing through the cladding layer. This alternative method has the advantage that the thin film heater elements do not need to be etched away.

It is preferable to anneal the non-ore regions at a temperature above approximately 700° C., as above this temperature the present inventor has found that a substantial change in the refractive index is produced.

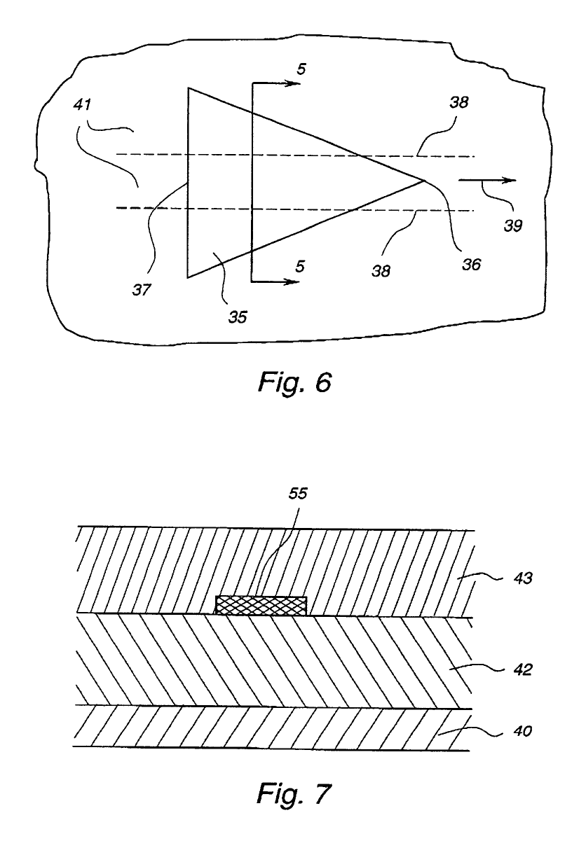

A method of producing a waveguide having a core with non-uniform refractive index profile will now be described with reference to FIGS. 5 to 7. In FIG. 5 there is shown a substrate 40 on which has been formed a silica buffer layer 42 and a germanium-doped silica core-forming layer 41 using known processes such as PECVD. The technique involves locally modifying the refractive index in the core-forming layer 41 and then etching a core structure from the modified layer 41. In FIG. 6, dashed lines 38 indicate the boundaries of a core which will be formed in the core-forming layer 41 during a later step. Referring to FIG. 5, a thin film heating element 35 is formed over a localised region 50 of the core-forming layer 41. As shown in FIG. 6 the thin film heating element 35 tapers in the longitudinal direction indicated by arrow 39. The heating element 35 is then operated to anneal the region 50 of the core layer beneath the heating element with the narrower sections providing greater heat than the wider sections. After annealing, the core layer 41 has a refractive index profile that increases in the direction opposite arrow 39 from the region of highest annealing temperature (the region beneath the narrowest point 36 of the element 35) to the region of lowest annealing temperature (the region beneath the widest section 37 of the element).

Referring to FIG. 7, the heater element 35 is removed after the annealing step by etching, and the core layer 41 is formed into the desired shape 55 (shown in dashed lines 38 in FIG. 6) using photolithographically-defined etching. Finally, the etched core 55 is coated with a cladding layer. The resultant waveguide has a refractive index profile which changes gradually along an optical propagation axis of the waveguide.

A waveguide having a tapered refractive index profile can be used, for example, in coupling waveguides of different dimensions.

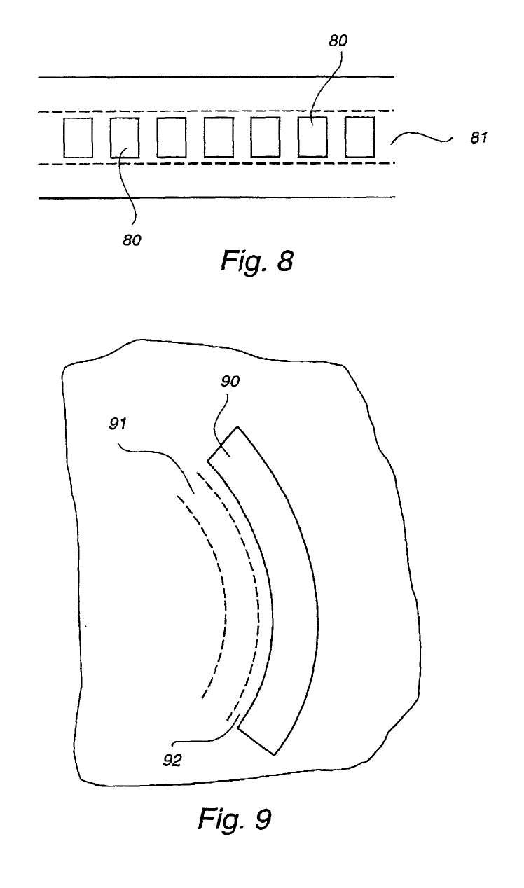

An alternative to using a tapered heating element in order to form a tapered heating profile is to deposit an array of individual heating elements 80 in a longitudinal direction over the core section 81 to be annealed, as illustrated in FIG. 8. Each heating element 80 in the array can be supplied with an individual heating current. By increasing the heating duration and/or heating current to the elements in the direction in which the level of annealing is to increase, a tapered refractive index profile can be produced. Such an array of heating elements may be used before formation of the cladding layer, either before or after shaping of the core. Alternatively, as with the embodiment shown in FIGS. 6-7, annealing may occur through the cladding layer by forming the heating elements after depositing the cladding layer. In a further embodiment, a waveguide having a tapered refractive index in the core is produced using the method described above with reference to FIGS. 1 to 3 by depositing a first series of thin film heaters over non-core regions of the core-forming layer and a second series of heaters in a longitudinal direction along the core region of the core-forming layer. The first series of heaters can be operated at a high temperature to produce a strong contrast in refractive index to define the core region whilst the second series of heaters are operated at a lower temperature that varies in the longitudinal direction to produce a tapered refractive index in the core.

The method of the invention may further be used to reduce bend losses in bent waveguides. Bend losses occur on the outside curvature of a bend and can be reduced by increasing the contrast in refractive index between the core and the adjacent cladding. Referring to FIG. 9, by forming a curved heating element 90 over the cladding 92 disposed adjacent the bent core section 91 on the outside curvature thereof and annealing this section, a greater contrast in the refractive index between the core and cladding can be produced, thereby increasing the confinement and reducing bend losses. The confinement can be increased in particular by annealing the outside curvature cladding above approximately 700° C.

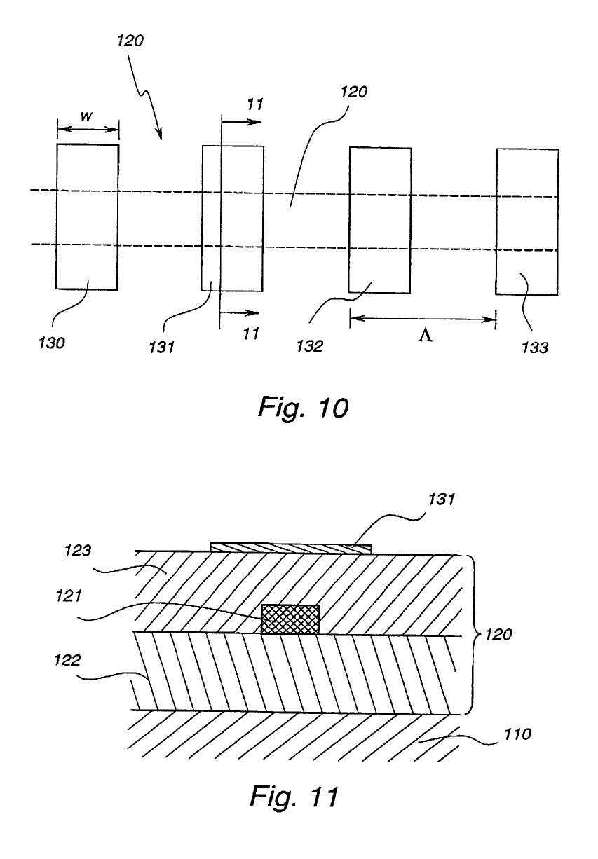

A further application of the invention is in the writing of photonic gratings and in particular, long-period gratings. Referring to FIGS. 10 and 11 there is shown generally a silica-based waveguide 120 comprising a germanium-doped channel core 120 encapsulated in silica. A series of thin film heaters 130, 131, 132, 133 are formed along the length of the waveguide 120. The heaters are spaced by a distance Λ, which may be constant or changing, and are of width w. It will be understood that in order to supply electrical current to the heaters 130-133, it is necessary to provide contact pads and electrical connections to the heaters, but these features are omitted from FIG. 11 for simplicity. In general, electrical connections to the heaters 130-133 should exhibit a lower electrical resistance than each heater, such as by forming the electrical connections with greater cross-sections dimensions (wider and/or thicker connections) than the heaters. One or more of the heaters 130-133 may be powered separately. Alternatively, some or all of the heaters may be connected in series and powered by a single source of current.

As shown in detail in FIG. 11, the waveguide 120 is deposited on a silicon substrate 110 and comprises a germanium-doped silica core 121 formed between a silica buffer layer 122 and a silica cladding layer 123. The waveguide 120 is formed on the substrate 110 using a known process such as Plasma-Enhanced Chemical Vapour Deposition (PECVD).

The thin film heaters 130, 131, 132, 133 are deposited on the top of waveguide structure 120 as illustrated in FIG. 10 using known deposition techniques. Each thin film heater extends at least across the width of the core of the waveguide 121. The thin film heater is capable of producing a power density sufficient to heat the waveguide structure 120 above the formation temperature T₁ and preferably up to just below the melting temperature of the waveguide structure. The heaters are connected to contact pads (not shown) for connection to a power supply for supplying a heating current to the heaters.

Once the waveguide 120 and thin film heaters have been formed, the waveguide can be analysed using known techniques to determine its refractive index profile and thus the extent of annealing required. The heaters are then operated by supplying a heating current from contact pads to heat the regions of the waveguide beneath the heaters to an annealing temperature e.g. 750-800° C., which is above the formation temperature of the waveguide but less than the melting temperature of materials from which the waveguide is formed. This heating process lowers the effective refractive index in the waveguide relative to the unheated regions. Thus, by selecting the regions to be annealed so that they have a specific spaced relationship, a grating can be written into the waveguide. A further step of determining the refractive index of the waveguide in the selected regions can be performed during the annealing stages if necessary.

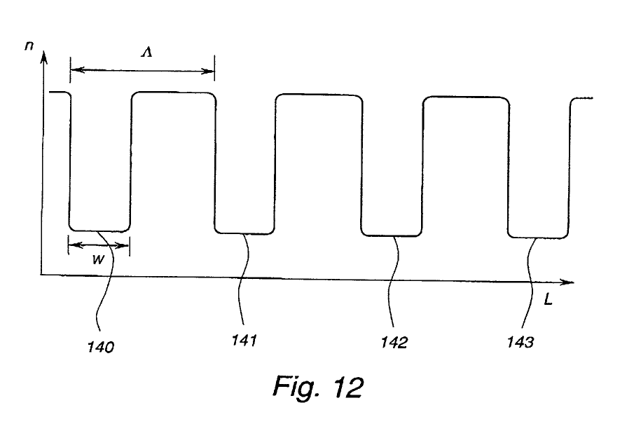

FIG. 12 shows a schematic graph of the refractive index n along the length L of the waveguide after the annealing process has been conducted. As is seen in the graph, the waveguide grating includes a series of regions 140, 141, 142, 143 of reduced refractive index corresponding to the annealed regions. The regions 140, 141, 142, 143 are of width w corresponding substantially to the width of the heaters 130, 131, 132, 133. The grating wavelength Λ, or spacing between regions 140, 141, 142, 143 corresponds substantially to the spacing between the heaters. Although FIG. 12 schematically shows very sharp transitions between regions of high refractive index and regions of low refractive index, a person skilled in the art will understand that in practice the transitions will be more gradual than shown here.

The formation temperature T₁ is selected according to the requirements of the waveguide to be produced. In the absence of other requirements, it is preferred that T₁ is approx. 350° C. to allow a grating to be produced with a maximum change in refractive index between annealed and unannealed regions.

The grating wavelength Λ is determined by the spacing between annealed regions and will depend on the wavelength to be affected by the grating. To be most effective, the width w of the annealed regions, and thus the width of the heaters is related to the grating wavelength according to the relationship

$$\frac{Λ}{5} \leq w \geq \frac{4 Λ}{5} .$$

In a most preferred form, the width w is half the grating wavelength Λ.

For long period gratings the grating wavelength Λ, and thus the spacing between the heaters is between 50 μm and 1500 μm.

Depending on requirements of the grating, the grating wavelength Λ may be constant or changing. For a chirped grating, the wavelength Λ will alter, i.e. increase or decrease, by a constant amount between successive regions along the length of the grating.

There can be circumstances in which it is necessary to control the magnitude of an annealing-induced refractive index change, This can be achieved by controlling the temperature of each heating element, which is in turn controlled by selecting an appropriate cross-sectional area for each heating element and/or adjusting the electrical current supplied to the heating element. For example, in order to produce an apodized grating, the selected regions at the ends of the grating are annealed to a lesser extent by heating to a lower temperature than the regions between the ends of the grating.

The embodiments of the invention have been described with reference to depositing the waveguide at a temperature below the melting point of the waveguide material and then annealing at a temperature between the formation temperature and the melting point. However, it may also be suitable, though less preferred, to deposit the waveguide at temperatures above the melting point, e.g. using known techniques such as flame hydrolysis of a suitable precursor powder, followed by annealing at a temperature below the melting point.

It will be understood by the person skilled in the art that numerous modifications and/or variations may be made to the invention as described without departing from the spirit or scope thereof and all such modifications and/or variations are intended to be embraced herein.

We claim:

1. A method of forming a photonic waveguide structure comprising the steps of forming a silica-based waveguide on a substrate, said formed waveguide having a first refractive index profile; and annealing one or more localised regions of said waveguide to permanently set a new refractive index profile in said localised regions.

2. A method according to claim 1 wherein the step of annealing comprises the step of forming one or more heater elements over said localised regions and operating the or each heater element to heat said localised regions to a temperature sufficient to permanently set the refractive index of said localised regions.

3. A method of forming a photonic waveguide comprising the steps of: forming a buffer layer on a planar substrate; forming a silica-based core-forming layer on said buffer layer; heating one or more selected regions of said core-forming layer to a temperature sufficient to permanently reduce the refractive index of said selected regions; and forming a cladding layer over said core-forming layer;
wherein said selected regions define the boundaries of a light-guiding core within said core-forming layer having a higher refractive index relative to said selected regions.

4. A method according to claim 3 wherein the step of heating said selected regions comprises forming one or more heater elements over said selected regions of said core-forming layer and operating the or each heater element to heat said selected regions.

5. A method according to claim 4 wherein the steps of forming and operating the or each heater element occurs prior to formation of said cladding layer.

6. A method according to claim 5 further including the step of removing the or each heater element prior to forming said cladding layer.

7. A method according to claim 4 wherein the steps of forming and operating the or each heater element occurs post formation of said cladding layer.

8. A method according to claim 3 wherein the waveguide is formed at a temperature lower than the melting temperature of the material of the waveguide and wherein the step of annealing comprises heating said selected regions of the waveguide to a temperature above the formation temperature of the waveguide and below the melting temperature of the waveguide.

9. A method according to claim 3 wherein said core-forming layer is formed with a higher material density than at least one of said cladding layer and said buffer layer.

10. A method of modifying a planar silica-based waveguide comprising a light-guiding core at least partially encapsulated in a cladding region, the method comprising: heating a selected portion of the cladding region adjacent said core so as to permanently reduce a refractive index of the selected portion and to increase a contrast in refractive index between said selected portion and said core.

11. A method according to claim 10 wherein the step of heating comprises the step of forming one or more heating elements over said selected portion and operating said one or more heating elements to heat said selected portion.

12. A method according to claim 10 wherein said selected portion of said cladding is a portion adjacent said core and on an outside curvature of a bend in said core.

13. A method of producing a planar waveguide comprising the steps of: forming a planar silica-based waveguide including a core; non-uniformly annealing at least a portion of said waveguide core so as to produce a non-uniform refractive index profile in said annealed portion of said waveguide core.

14. A method according to claim 13 wherein said portion is annealed by applying a heat density gradient that varies along an optical propagation axis of said waveguide so as to produce a permanent refractive index profile which varies along said propagation axis.

15. A method according to claim 13 wherein said annealing step comprises the steps of forming one or more heater elements over said portion of said waveguide and operating the or each heater elements to anneal said portion.

16. A method according to claim 15 wherein the heater element comprises a tapered heating element.

17. A method according to claim 15 wherein the or each heater element comprises an array of separately-powered heating elements formed over sections of said waveguide, wherein each heating element provides a separate heat density to the respective section of the waveguide.

18. A method according to claim 13 wherein said annealing is applied to a core of said waveguide prior to formation of a cladding layer.

19. A method according to claim 13 wherein said annealing is applied to a core of said waveguide post formation of a cladding layer.

20. A method of writing a grating in a photonic waveguide, comprising the steps of forming a silica-based waveguide including a core, heating a plurality of selected regions of said core to a temperature sufficient to permanently alter the refractive index of said selected regions, wherein said selected regions have a predetermined spaced relationship relative to each other.

21. A method according to claim 20 wherein said heating step comprises depositing at least one thin film heating structure over said selected regions and operating the or each heating structure to heat said selected regions.

22. A method according to claim 20 wherein said selected regions are in the form of a Bragg grating.

23. An optical waveguide structure comprising a silica-based planar optical waveguide, at least one heater operable to heat a plurality of selected regions of said waveguide, said regions having a predetermined spaced relationship relative to each other, wherein the or each heater is operable to heat at least a core of said waveguide to an annealing temperature so as to alter the effective refractive index of said selected regions.

24. An optical waveguide grating comprising a silica-based planar optical waveguide and one or more heaters operable to heat a plurality of selected regions of said waveguide, said regions having a predetermined spaced relationship relative to each other, wherein said selected regions have been heated by said one or more heaters to alter the refractive index of said selected regions to produce said grating.

25. A silica-based planar waveguide comprising a substrate; a buffer layer formed on said substrate; a core formed on said buffer layer; and a cladding layer formed on said core; wherein said core is bounded on one or more sides by selected regions of relatively lower refractive index, the refractive indices of said selected regions having been defined by annealing at a temperature sufficient to permanently reduce the refractive index of said selected regions relative to said core region.

26. A planar waveguide comprising a core section and a silica-based non-core section disposed adjacent said core section, wherein said non-core section has been annealed to a temperature sufficient to permanently increase the refractive index contrast between said core section and said non-core section.

27. A planar waveguide comprising a silica-based core region that has been annealed so as to produce a refractive index profile in said core region that varies along an optical propagation axis of the waveguide.
